(19) United States
(12) Patent Application Publication
(10) Pub. No.: US 2007/0137564 A1
(43) Pub. Date: Jun. 21, 2007

(54) Masking means for covering a section of a steel part or iron part in a coating process

(76) Inventor: Volker Beckord, Hannover (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 10/556,638

(22) PCT Filed: May 14, 2004
(86) PCT No.: PCT/EP04/05199

§ 371 Date: Aug. 29, 2006

(30) Foreign Application Priority Data
May 14, 2003 (DE) 103 21 700.2

(51) Int. Cl. B05C 11/11

(52) U.S. Cl. 118/504

(57) ABSTRACT

Disclosed is a masking means for covering a section (12-3) of a steel sheet or iron sheet in a coating process, especially a section of a vehicle body or a housing of an appliance during a lacquering or preservation process. Said masking means is embodied as a quasi endless profiled member or injection-molded part (10-3) that is made primarily of plastic and is provided with a finely distributed magnetic or magnetizable admixture, particularly ferrite particles.

The present invention relates to a masking means in accordance with the preamble of main claim 1.

Such type of masking means are intended for partially covering sections of steel parts or iron parts on which they are supposed to be placed at least temporarily for the duration of a corresponding process step for the purpose of ensuring a sufficiently secure adhesion. Said steel parts or iron parts are particularly steel sheets or iron sheets and especially automobile bodies and/or bodywork parts and housings and parts of appliances or equipment that are made of steel sheet, are lacquered and/or protected in any other way from corrosion or are provided with a surface finish for any other reason.

Based on the known prior art, the objective underlying the present invention is to provide a masking means that is applicable cost-effectively and is easily manageable.

This objective is achieved by a masking means having the characteristics specified in claim 1 or 2. Expedient embodiments of the present invention form the object of the dependent claims.

An essential thought of the present invention is to utilize the magnetic properties of the sections of the steel part or iron part intended for the coating. This is made possible by the fact that the masking means used also has magnetic or magnetizable components. Concretely, two basic embodiments of the masking means according to the present invention are feasible that are described here individually in the following explanation.

Such a masking means can firstly be embodied as a quasi endless profiled member or injection-molded part that is made primarily of plastic and is provided with a finely distributed magnetic or magnetizable admixture, particularly ferrite particles. Alternatively, the masking means according to the present invention can comprise at least one plastic profiled member or plastic injection-molded part for covering the surface and a permanently magnetic or magnetizable fastener that can be placed on or inserted into the plastic profiled member or plastic injection-molded part or that is connected to the latter using a force transmitting member and that holds said plastic profiled member or plastic injection-molded part on the steel sheet or iron sheet using magnetic force.

By utilizing the holding force conveyed by the magnetic component/s, the component/s of the masking means according to the present invention that is/are used for the purpose of masking can be attached to the steel or iron components and can also be removed from the steel or iron components after the coating process easily and quickly. It is thus possible to omit a complicated shaping of the profiled members used for the purpose of masking in order to fasten said profiled members to the component using molded holding means. The masking means can thus be manufactured more cost-effectively.

In a design of the second masking means according to the present invention described here, the fastener comprises a (plastic) covering on all surfaces that are essentially not in contact with the plastic profiled member or plastic injection-molded part. Masking means are no longer useable after a certain number of coating processes and sometimes even after one application. This design form makes it possible to protect the magnetizable fastener during the coating process/es in view of a longer utilization period while the other components of the masking means, for instance, the plastic covering are disposed of or recycled. Due to this, the costs for using the masking means according to the present invention are further reduced.

In an alternative design of the second embodiment, the fastener is inserted into a cavity in the plastic profiled member or the plastic injection-molded part. It is thus possible to omit a covering of the fastener as an additional component. Thus depending on the concrete application, it is possible to simplify an automatic attachment/removal of the masking means to or from the steel or iron component to be masked.

In an improvement of both these design forms, the fastener can be snapped into position in the plastic covering or in the plastic profiled member or the plastic injection-molded part. This enables a particularly simple and fast assembly of the components of the masking means according to the present invention. This also applies to the replacement of the plastic components of the masking means after a certain number of coating processes, and/or after the further use of the fastener. The fastener can be unlocked and thereafter removed from the plastic components by bending or twisting them.

In another embodiment based on one of the two basic embodiments described above, the masking means according to the present invention comprises at least one side-section that is curved and/or that is cut out from a lower side turned towards the steel sheet or the iron sheet whereby the side edge of said side-section that is turned away from a base body is springily pressed against the steel sheet or the iron sheet. In many respects, this embodiment is advantageous depending on the concrete application, for example, in order to overstretch depressions in the masked component or parts projecting from the masked component such as screws, rivets and the like.

In other embodiments of the masking means according to the present invention, said masking means comprises a hold-down device that is integrated into or connected to the profiled member and/or the injection-molded part or into the plastic covering for supporting an additional plastic profiled member or plastic injection-molded part. Thus, a masking means can also be advantageously used for fastening an additional, e.g., conventional masking means. Combinations of masking means are also feasible, where an elongated plastic profiled member is fastened using two or more fasteners.

In other embodiments of the masking means according to the present invention, said masking means comprises a recyclable plastic that is heat-resistant up to approximately 180° C. and that has a predetermined flexibility particularly in the longitudinal direction. Thus, the masking means can be advantageously intended for a variety of coating processes, for instance, with powder coating to be melted. Since some components of the masking means have to be replaced more frequently, the use of recyclable plastic is advantageous for purposes of environment protection. Depending on the concrete application, a predetermined flexibility, e.g., of the masking plastic profiled members can facilitate the attachment process according to the contours of the components.

In other embodiments of the masking means according to the present invention, said masking means is embodied as an extruded profiled member. Due to this, plastic components of the masking means can be manufactured easily and cost-effectively. Furthermore, after the extrusion process, the masking means can be cut to size depending on the concrete application. If a fastener is provided, that consists of one or more magnets; these magnets can be inserted after the extrusion or immediately before the application.

Expedient embodiments of the masking means according to the present invention have an average width ranging between 15 and 60 mm, particularly between 35 and 40 mm. It is thus possible to meet the requirements of the maskings most frequently found, for instance in the automobile industry.

Additional aspects, advantages and expediencies of the present invention will become apparent on the basis of the following description of embodiments of the masking means according to the present invention in conjunction with the figures, of which:

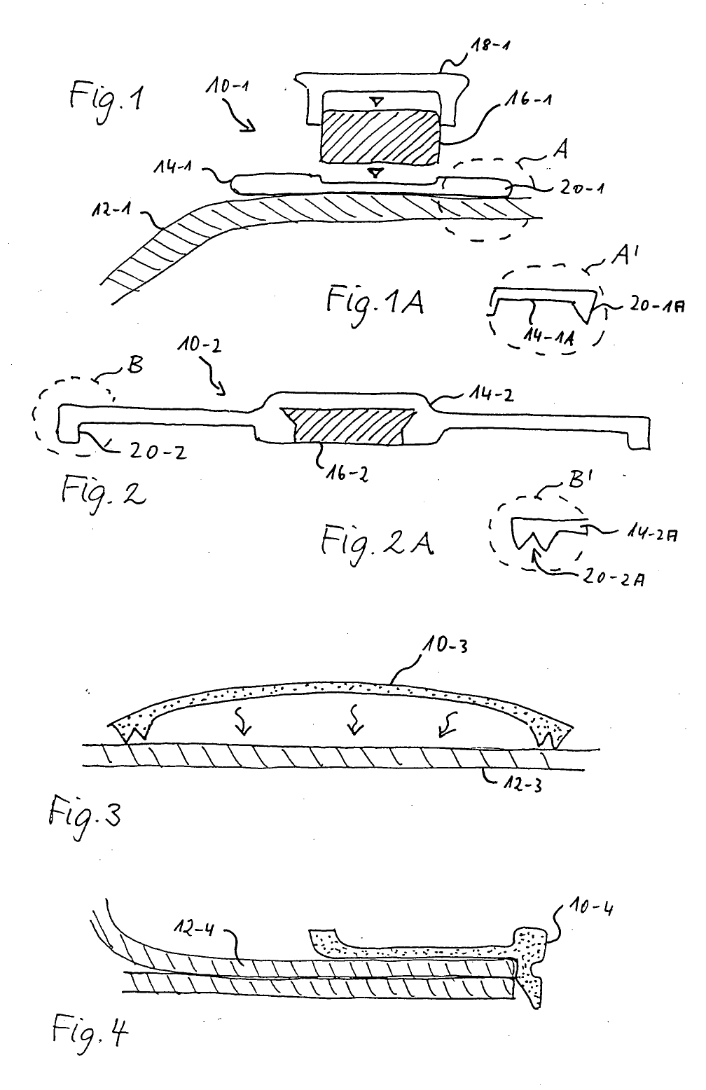

FIG. 1 illustrates a first embodiment of a masking means according to the present invention,

FIG. 1A illustrates a modification of the embodiment illustrated in FIG. 1,

FIG. 2 illustrates a second embodiment of a masking means according to the present invention,

FIG. 2A illustrates a modification of the embodiment illustrated in FIG. 2,

FIG. 3 illustrates a third embodiment of the masking means according to the present invention,

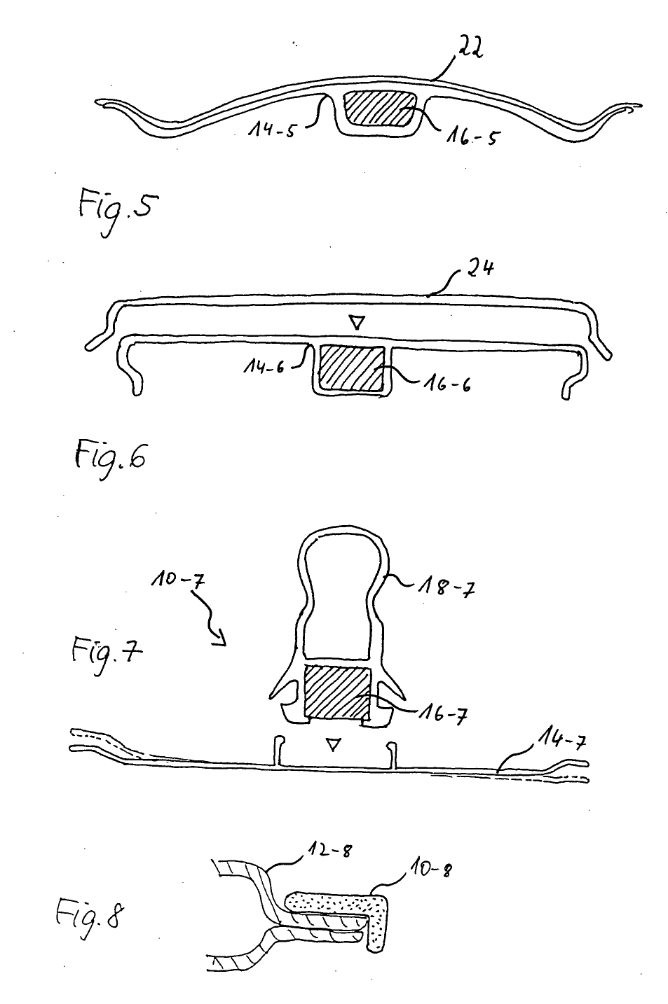

FIG. 4 illustrates a fourth embodiment of the masking means according to the present invention,

FIG. 5 illustrates a fifth embodiment of the masking means according to the present invention,

FIG. 6 illustrates a sixth embodiment of the masking means according to the present invention,

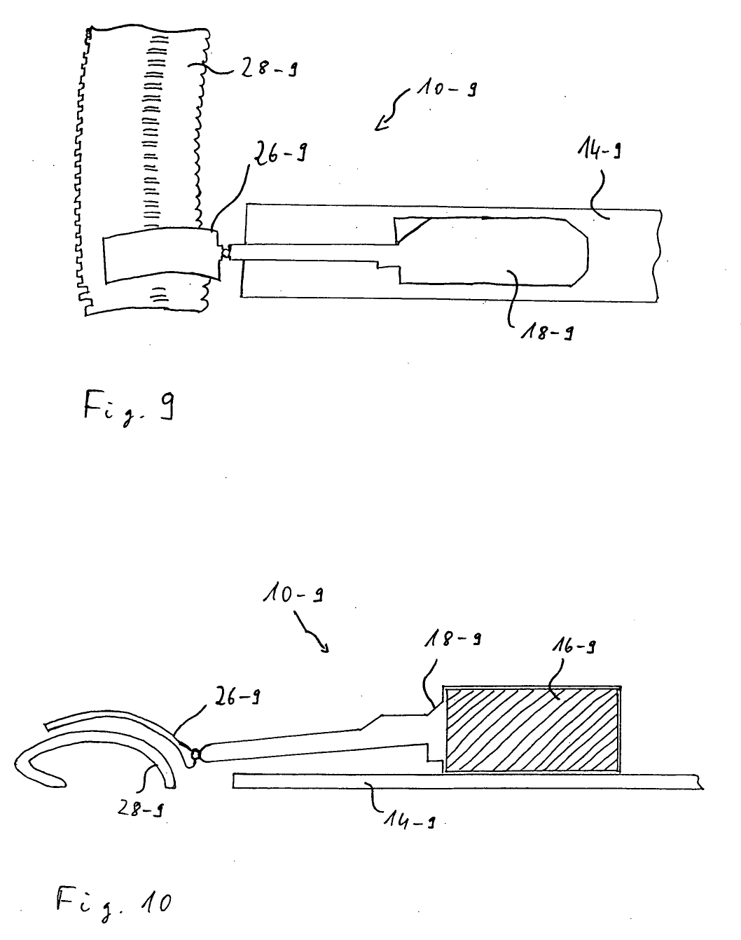

FIG. 7 illustrates a seventh embodiment of the masking means according to the present invention,

FIG. 8 illustrates a modification of the masking means illustrated in FIG. 4,

FIG. 9 illustrates a top-view of an eighth embodiment of the masking means according to the present invention,

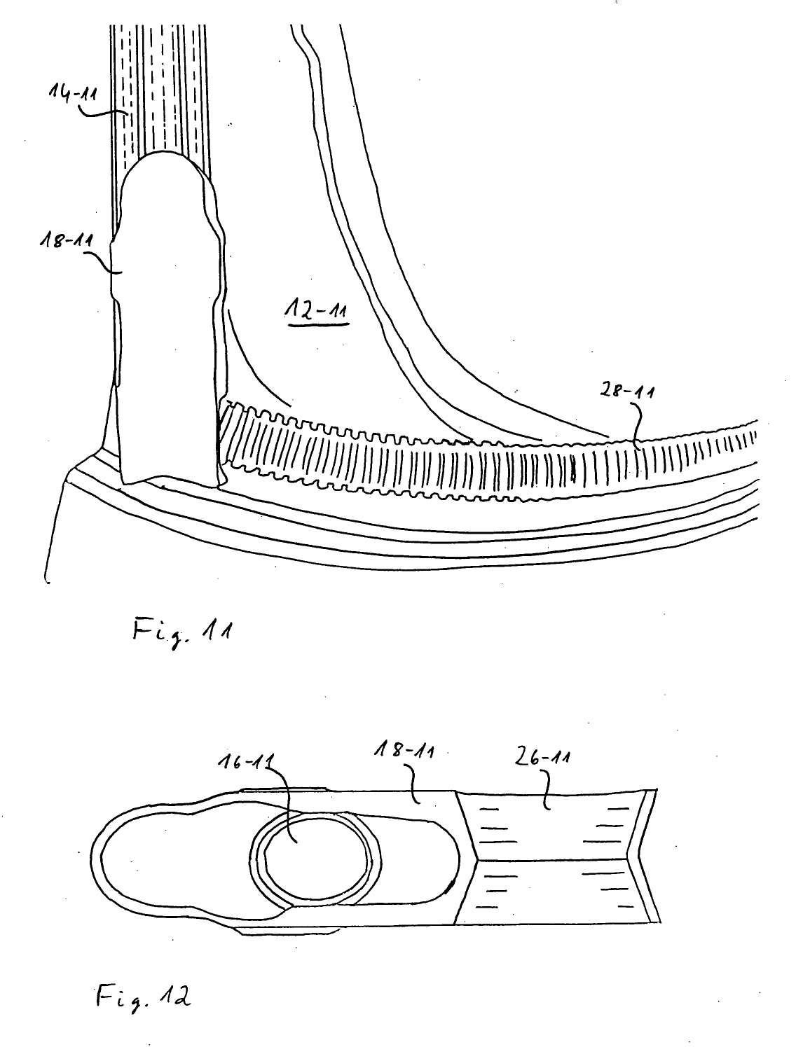

FIG. 10 illustrates a side-view of a part of the masking means illustrated in FIG. 9,

FIG. 11 illustrates a top-view of a ninth embodiment of the masking means according to the present invention,

FIG. 12 illustrates a top-view from below of a part of the masking means illustrated in FIG. 11.

In FIGS. 1 to 8, steel and/or iron parts are each illustrated in a hatched form with a greater distance between the lines and magnetic or magnetizable fasteners are illustrated in a hatched form with a smaller distance between the lines. Plastic parts having magnetic or magnetizable inclusions are illustrated in a dotted form while only plastic parts are illustrated without any markings on the cut surfaces. The small triangles in the figures symbolize the possibility of a configuration of multi-part masking means.

FIG. 1 illustrates a schematized side-view of a masking means 10-1 that is placed on a steel component 12-1 intended for lacquering. The masking means 10-1 comprises of a plastic profiled member 14-1, a permanent magnet 16-1 as well as a plastic covering 18-1. The plastic profiled member 14-1 serves for masking the component 12-1 during the subsequent lacquering. The profiled member 14-1 is manufactured in an extruder and comprises of heat-resistant plastic, in order to withstand the high temperatures occurring during the lacquering process. After a certain number of lacquering processes, the profiled member 14-1 has to be replaced and it is therefore manufactured advantageously from recyclable plastic.

The plastic profile 14-1 is fixed on the steel component 12-1 using the magnet 16-1. For this purpose, the machine operator first places the profiled member 14-1 on or against the steel component 12-1 and thereafter fixes the profiled member 14-1 by placing the magnet 16-1. For better handling of the magnet 16-1 and also for its protection in the subsequent lacquering process, the magnet 16-1 is surrounded by or inserted into the plastic covering or the plastic casing 18-1. As can be seen in FIG. 1, the cohesion of the covering 18 and the magnet 16 can take place by joining both the elements together using form-fit connection. Many other options will also become apparent to a person of skill in the art. However, the connection between the components 18-1 and 16-1 of the masking means 10-1 ought to be detachable since the covering 18-1 must be replaced just like the profiled member 14-1 after a certain number of lacquering processes. For this purpose it is advantageous that the covering 18-1 also is made of recyclable plastic.

FIG. 1A illustrates a section A′ of a modified example as compared to the embodiment illustrated in FIG. 1. Here, the section A′ corresponds to the section A in FIG. 1 that is indicated using the dashed line. In the modification, the profile 14-1A does not lie flat and extensively on the steel component (not illustrated in FIG. 1A), instead it lies only in a central region on which the magnet is placed as well as peripherally over a bead edge 20-1A that is formed along at least one part of the peripheral edge of the profile 14-1A.

As also illustrated in the subsequent figures, manifold designs are possible depending on the application when designing the peripheral edge of the profiled member 14. In case of a bead edge 20-1A that is designed as sharp-edged towards the steel component as illustrated in FIG. 1A, a very sharp delimitation of the lacquered from the non-lacquered region of the component is achieved. Furthermore, a distancing of the plastic profiled member from the component achieved by using the bead edge 20-1A (and other embodiments of such an edge) can be advantageous if the component is molded in a slightly complex way (depressions, grooves or even projections) without requiring the masking means to follow these contours.

FIG. 2 illustrates a masking means 10-2 according to the present invention. Here the magnet 16-2 is accommodated in the plastic profiled member 14-2. A plastic covering as an additional component of the masking means as in the first embodiment can thus be omitted here. The magnet 16-2 can be inserted immediately after the profiled member 14-2 emerges from the extruder. The number of the magnets 16-2 to be inserted into the corresponding notch of the profiled member 14-2 is determined according to the length of the profiled member 14-2 (vertical to the plane of the drawing) as well as the required adhesive effect. Experiments can be conducted for this purpose for every concrete application.

The magnets 16-2 can be simply locked into place or clamped or snapped into position in the profiled member 14-2, i.e., the magnets are pressed mechanically or manually into the cavity of the profiled member intended for this purpose and they lock into position in the cavity. If the profiled member 14-2 must be replaced after a certain number of lacquering processes, then the magnets 16-2 can be snapped out of the cavity by simply bending the flexible profiled member 14-2 and thereafter snapped into position in a replacement profiled member.

FIG. 2A illustrates a section B′ of a modified example as compared to the embodiment illustrated in FIG. 2, whereby the section B′ corresponds to the section B indicated by the dashed line in FIG. 2. The sections B and B′ illustrate additional expedient modifications 20-2 or 20-2A of bead edges of plastic profiled members (14-2 or 14-2A) according to the present invention.

For typical applications, the width of a plastic profiled member 14 in case of the first and the second embodiment amounts to approximately 35-40 mm and the thickness (without bead edge) amounts to approximately 0.2-0.5 mm or up to 1 mm (with bead edge).

FIG. 3 illustrates a masking means 10-3 that is designed as a single piece. Ferrite particles are added to an extrusion granulate for manufacturing the plastic profiled member 10-3. The completely extruded profiled member is magnetized after the extrusion process. The single-piece profiled member 10-3 of this example is suited particularly for the automatic mounting on the steel component 12-3, for example using a robot. After the lacquering process, the profiled member 10-3 can be dismounted advantageously by means of a steel tool using magnetism and the process of dismounting can also take place automatically. The plastic profiled member 10-3 can be demagnetized before the recycling process.

The profile 10-3 is embodied as a hollow profiled member. Thus one and the same profiled member can be used for variably molded steel components, particularly those that are molded in a complex way inside the region that is masked by the masking means. Due to this, even projecting components, e.g., rivets or screws can be easily covered by the masking means.

FIG. 4 illustrates a profiled member 10-4 whose plastic material is or becomes magnetized using admixtures. The masking means 10-4 must be attached to flanges 12-4 made of steel sheet. The profiled member 10-4 can be molded more easily as compared to a masking means according to prior art since there is no requirement of any clamping effect of the profiled member for the retention on the components 12-4. Rather the magnetic force action between the parts 12-4 and the profiled member 10-4 provides the required fixation.

Complicated sections or cutouts on the profile 10-4 can thus be avoided when manufacturing the profiled member. In addition, the profiled member 10-4 enables a window-flange covering in vehicle models having flange sight area (low-priced equipment without covering) whose insides are lacquered. Since a clamping effect need not be achieved, even a more cost-effective plastic material can be used for the profiled member 10-4 than that used for the masking means according to prior art.

FIG. 5 illustrates a plastic profiled member 14-5 that is not magnetized, instead is held against a steel or iron component (not illustrated here) using a magnet 16-5. In this example, the cavity for accommodating the magnet is embodied in a tubular form (vertical to the plane of the drawing) and thus encloses the magnet/s 16-5 completely. A separate plastic covering for the magnets can thus be omitted.

On its side that is turned away from the steel component, the profiled member 14-5 is covered with a covering tape 22 in the form of an adhesive tape. This covering tape is sealed against lacquer application and can be pulled off and replaced either after every lacquering process or after a plurality of lacquering processes. Thus the plastic profiled member 14-5 can be used with the magnet/s 16-5 for any number of lacquering processes. The covering 22 can also be an adhesive foil.

FIG. 6 illustrates a plastic profiled member 14-6 that is protected by a plastic covering 24 instead of a covering tape, where said plastic covering seals it against lacquer application. The plastic covering is easily locked into position with the plastic profiled member 14-6 or snapped into position on the plastic profiled member before the lacquering process at the latest. The covering 24 advantageously consists of recyclable plastic. After a certain number of lacquering processes, the covering 24 is then replaced. The parts 24 and 14-6 can be snapped out of place, for example, using a two-way twisting action.

FIG. 7 illustrates a plastic profiled member 14-7 that is thin (however, still thick enough to seal against lacquer application) and thus can be adjusted very flexibly to different contours of a component (not illustrated). In this embodiment also, the profiled member is seated very firmly on the component.

The magnet 16-7 is protected by the plastic covering 18-7 during the lacquering process. The covering 18-7 is molded as a grip profiled member here in order to enable the machine operator or the robot to handle the magnet 16-7 and/or the masking means 10-7 easily and quickly. It is also possible to reequip the grip profiles 18-7 in an easy way.

The covering 18-7 can be snapped into place in the profiled member 14-7 and thus provides additional retention for the magnet 16-7 on the profile. The covering and the profiled member can be snapped together either directly after manufacturing the parts 14-7 and 18-7 or only immediately before the use of the masking means 10-7 so as to enable transport and storage of the masking means 10-7 in a space-saving manner.

FIG. 8 illustrates a modification of the masking means illustrated in FIG. 4. Here, the magnetized or magnetizable plastic profiled member 10-8 is molded with particular ease. The masking means 10-8 can be manufactured very cost-effectively by economizing on the molding steps when manufacturing the profiled member 10-8. Therefore the masking means is suited for one-time usage or for usage as a masking means that can be replaced frequently.

FIG. 9 illustrates a top-view of a masking means 10-9. It comprises a plastic profiled member or a separate profiled member 14-9. Compared to the embodiment illustrated in the section in FIG. 1, a permanent magnet is placed on the plastic profiled member or the separate profiled member. Said permanent magnet is protected by a plastic covering or a replaceable cap 18-9. A hold-down device 26-9 is attached to the replaceable cap 18-9. The free end of the hold-down device is molded so as to hold down an additional masking element, namely a corrugated pipe 28-9 for masking a body flange of an automobile.

The side-view of the replaceable cap 18-9 of the masking means 10-9 is illustrated in the section in FIG. 10. Here it must be pointed out that the replaceable cap accommodates the magnet 16-9 and the hold-down device 26-9 is embodied as an extension arm of the replaceable cap 18-9. The molding of the hold-down device 26-9 is adjusted to the diameter or the curve of the corrugated pipe 28-9.

FIG. 11 schematically illustrates a ninth embodiment of a masking means according to the present invention. Here, a plastic profiled member 14-11 is placed on a steel sheet 12-11 having a complex molding. A plastic covering 18-11 with integrated magnets (compare the subsequent figure) is placed on the plastic profiled member. The profiled member 14-11 is fixed on the component 12-11 using the magnets. As in the previously described embodiment, here also the plastic covering 18-11 is designed simultaneously as a hold-down device that serves for holding down a corrugated pipe 28-11.

Both the profiled member 14-11 as well as the corrugated pipe 28-11 stretch over comparatively large distances. They are then each fixed or held down advantageously on their ends (not illustrated in FIG. 11) using an additional plastic covering having integrated magnets.

FIG. 12 illustrates a top-view from below of the plastic covering 18-11 shown in FIG. 11. The covering 18-11 has a cavity for accommodating at least one magnet 16-11. The magnet is fastened by simply inserting it into the covering 18-11. As can be seen in FIG. 12, a second or a third magnet can be inserted in order to increase the adhesive effect on the steel sheet 12-11 (compare FIG. 11), if necessary.

As shown in the example, embodiments of the masking means having several components are possible within the framework of the present invention that can be assembled by the machine operator on site and also profiled structures that are assembled immediately after manufacturing the corresponding plastic part, for example after extruding a plastic profiled member, and are delivered in this state into the coating unit.

It goes without saying that the extruded plastic profiled members (with or without admixtures of magnetic particles) can be cut to length or cut to size on site. Furthermore, it is possible within the framework of the invention to fix longer plastic parts to the carrier using several individual fasteners instead of one continuous long fastener. The assembly on the product to be coated (vehicle body, housing of an appliance and the like) can take place manually or automatically, e.g., using robots.

In the automatic lacquering process, the masking means suggested above serves particularly for masking window flanges and the like, vehicle body-edge sections, especially in the region of the water tank/windshield, trunk/rear window, B-pillar, C-pillar, D-pillar and the rear hood.

In addition to the embodiments of the masking means according to the present invention that are illustrated here, numerous other design forms are also feasible that are adapted to the respective concrete application. In contrast, the scope of the present invention is specified exclusively in the subsequent claims.

### LIST OF REFERENCE SYMBOLS

10-1, -2, -3, -4, -7, -8, -9,—Masking means
11
12-1, -3, -4, -8, -11 Steel component
14-1, -2, -5, -6, -7, -9, -11 Plastic profiled member
16-1, -2, -5, -6, -7, -9, -11 Magnet
18-1, -7, -9, -11 Plastic covering for magnet
20-1, -1A, -2, -2A Bead edge
22 Covering tape for plastic profiled member
24 Covering for plastic profiled member
26-9, -11 Hold-down device
28-9, -11 Corrugated pipe

1. Masking means for covering a section of a steel or iron part in a coating process, especially a section of a vehicle body or a housing of an appliance during a lacquering or preservation process, wherein
said masking means comprises a quasi endless profiled member or injection-molded part made primarily of plastic with a finely distributed magnetic or magnetizable admixture, said mixture comprising ferrite particles.

2. Masking means for covering a section of a steel or iron sheet in a coating process, especially a section of a vehicle body or a housing of an appliance during a lacquering or preservation process, said masking means comprising:
at least one plastic profiled member or plastic injection-molded part for covering the surface and a permanently magnetic or magnetizable fastener that can be placed on or inserted into the plastic profiled member or plastic injection-molded part or that is connected to the latter using a force transmitting member and that holds said plastic profiled member or plastic injection-molded part on the steel sheet or iron sheet using magnetic force.

3. The masking means of claim 2, wherein
on all surfaces that are essentially not in contact with the plastic profiled member or plastic injection-molded part, the fastener comprises a detachable covering that is made of the plastic material of the profiled member or the injection-molded part.

4. The masking means of claim 2, wherein
the fastener is inserted into a cavity in the plastic profiled member or the plastic injection-molded part.

5. The masking means of claim 2, wherein
the fastener can be snapped into position in the plastic covering or in the plastic profiled member or the plastic injection-molded part.

6. The masking means of claim 1, said masking mean comprising:
at least one side-section that is curved and/or that is cut out from a lower side turned towards the steel sheet or the iron sheet whereby the side edge of said side-section that is turned away from a base body is springily pressed against the steel sheet or the iron sheet.

7. The masking means of claim 1, said masking mean comprising:
a hold-down device that is integrated into or connected to the profiled member and/or the injection-molded part or the plastic covering for engaging with an additional plastic profiled member or plastic injection-molded part.

8. The masking means of claim 1, wherein said masking means:
comprises a recyclable plastic that is heat-resistant up to approximately 180° C. and that has a predetermined flexibility particularly in the longitudinal direction.

9. The masking means of claim 1, wherein:
said masking means comprises an extruded profiled member.

10. The masking means of claim 1, comprises:
an average width ranging between 15 and 60 mm.

11. The masking means of claim 1 comprises an average width ranging between 35 and 40 mm.
